(19) United States
(12) Patent Application Publication
(10) Pub. No.: US 2024/0188061 A1
(43) Pub. Date: Jun. 6, 2024

(54) TERMINAL, BASE STATION, AND COMMUNICATION METHOD

(71) Applicant: Panasonic Intellectual Property Corporation of America, Torrance, CA (US)

(72) Inventors: Shotaro MAKI, Kanagawa (JP); Ayako HORIUCHI, Kanagawa (JP)

(21) Appl. No.: 18/552,127

(22) PCT Filed: Dec. 7, 2021
(86) PCT No.: PCT/JP2021/044851

§ 371 Date: Sep. 22, 2023

(30) Foreign Application Priority Data
Mar. 26, 2021 (JP) 2021-053461

(51) Int. Cl. H04W 72/0453; H04W 72/20; H04W 72/51

(52) U.S. Cl. CPC H04W 72/0453; H04W 72/20; H04W 72/51

(57) ABSTRACT

A terminal is provided with a control circuit for setting a reception frequency resource of a second control signal received after receiving a first control signal in a first frequency resource to a second frequency resource including a frequency resource different from the first frequency resource, and a receiving circuit for receiving a second control signal in the second frequency resource.

### TECHNICAL FIELD

The present disclosure relates to a terminal, a base station, and a communication method.

### BACKGROUND ART

A communication system called the 5th generation mobile communication system (5G) has been studied. The 3rd Generation Partnership Project (3GPP), which is an international standards-developing organization, has been studying development of the 5G communication system in terms of both the development of LTE/LTE-Advanced systems and a New Radio Access Technology (also referred to as New RAT or NR), which is a new method not necessarily backward compatible with the LTE/LTE-Advanced systems (see, e.g., Non Patent Literature (hereinafter referred to as “NPL”) 1).

### CITATION LIST

### Non-Patent Literature

### NPL 1

### RP-181726, “Revised WID on New Radio Access Technology”, NTT DOCOMO, September 2018

### NPL 2

### RP-193238, “New SID on Support of Reduced Capability NR Devices”, Ericsson, December 2019

### SUMMARY OF INVENTION

However, there is scope for study on a method for enhancing a use efficiency of time resources in a terminal.

A non-limiting embodiment of the present disclosure facilitates providing a terminal, a base station, and a communication method each capable of enhancing a use efficiency of time resources in a terminal.

A terminal according to an embodiment of the present disclosure includes: control circuitry, which, in operation, configures a reception frequency resource for a certain control signal received after receiving a first control signal in a first frequency resource, to be a second frequency resource including a frequency resource different from the first frequency resource, the certain control signal being referred to as a second control signal; and reception circuitry, which, in operation, receives the second control signal in the second frequency resource.

It should be noted that general or specific embodiments may be implemented as a system, an apparatus, a method, an integrated circuit. a computer program, a storage medium, or any selective combination thereof.

According to an embodiment of the present disclosure, it is possible to enhance a use efficiency of time resources in a terminal.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates exemplary frequency switching:

FIG. 2 is a block diagram illustrating an exemplary configuration of a part of a base station;

FIG. 3 is a block diagram illustrating an exemplary configuration of a part of a terminal;

FIG. 4 is a block diagram illustrating an exemplary configuration of the base station;

FIG. 5 is a block diagram illustrating an exemplary configuration of the terminal:

FIG. 6 is a sequence diagram illustrating an exemplary operation of the base station and the terminal according to Operation Example 1;

FIG. 7 illustrates exemplary frequency switching according to Operation Example 1;

FIG. 8 is a sequence diagram illustrating an exemplary operation of the base station and the terminal according to Operation Example 2;

FIG. 9 illustrates exemplary frequency switching according to Operation Example 2;

FIG. 10 illustrates another exemplary frequency switching;

FIG. 11 illustrates still another exemplary frequency switching;

FIG. 12 illustrates an exemplary architecture of a 3GPP NR system;

FIG. 13 is a schematic diagram illustrating a functional split between NG-RAN and 5GC;

FIG. 14 is a sequence diagram of a Radio Resource Control (RRC) connection setup/reconfiguration procedure;

FIG. 15 is a schematic diagram illustrating a usage scenario of an enhanced Mobile BroadBand (eMBB), massive Machine Type Communications (mMTC), and Ultra Reliable and Low Latency Communications (URLLC); and

FIG. 16 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

Note that, in the following description, a radio frame, a slot, and a symbol are, for example, each a physical resource unit in a time domain, for example. For example, the length of one frame may be 10 milliseconds. For example, one frame may be configured by a plurality (e.g., 10, 20, or another value) of slots. Further, for example, the number of slots configuring one frame may be variable depending on the slot length. Furthermore, for example, one slot may be configured by a plurality (e.g., 14 or 12) of symbols. For example, one symbol is the smallest physical resource unit in the time domain, and the symbol length may vary depending on the subcarrier spacing (SCS).

Further, a subcarrier and a resource block (RB) are each a physical resource unit in a frequency domain. For example, one resource block may be configured by 12 subcarriers. For example, one subcarrier may be the smallest physical resource unit in the frequency domain. The subcarrier spacing is variable, and may be 15 kHz, 30 kHz, 60 kHz, 120 KHz, 240 kHz, or another value.

### [Bandwidth Part (BWP)]

In NR, for example, one BWP (e.g., bandwidth part) or a plurality of BWPs may be configured for a terminal (e.g., also referred to as a mobile station or User Equipment (UE)). For example, among a plurality of BWPs configured for the terminal, one or more BWPs may be activated. For example, the terminal may transmit and receive a radio signal in accordance with a parameter configured in a BWP that is activated at a certain time.

The parameter for configuring a BWP may include, for example, at least one of a frequency position, a bandwidth, SCS (subcarrier spacing), a CORESET, and a TCI state. For example, when a plurality of BWPs is configured for a terminal, different values are possibly configured individually for BWPs for the above-described parameters of the BWP.

Note that the CORESET is. for example, a parameter indicating a resource in which a downlink control channel (e.g., Physical Downlink Control Channel (PDCCH) is transmitted. For example. one or a plurality of CORESETs may be configured in each BWP. For example, one CORESET among a plurality of CORESETs configured in a BWP may be used at the time of transmission and reception. Further, the bandwidth of the CORESET may be configured to be equal to or less than the bandwidth supported by the terminal, for example.

Furthermore, the TCI state is, for example, a parameter one or a plurality of which can be configured in each BWP. For example, one TCI state among a plurality of TCI states configured in a BWP may be used at the time of transmission and reception. Transmission and reception whose TCI states are common can be herein regarded as having similar propagation path characteristics (in other words, Quasi-Colocation (QCL)).

### [Reduced Capability NR Devices]

In Release 17 (hereinafter, referred to as Rel-17 NR), a specification (e.g., Reduced Capability (RedCap)) is expected to be developed for realizing a terminal (e.g., NR terminal) whose power consumption or cost is reduced by limiting some of the functions or performance to support various use cases, compared to Release 15 or 16 (hereinafter, referred to as Rel-15/16 NR) (e.g., initial release of NR) (e.g., see NPL 2).

Note that such a terminal is sometimes referred to as a reduced capability NR device. RedCap, a RedCap terminal, NR-Lite, or NR-Light, for example.

In order to reduce power consumption or cost, reduction in computational complexity in the terminal has been studied, for example. One method for reducing the computational complexity in the terminal is, for example, a method for configuring a bandwidth supported by the terminal to be narrower than the bandwidth supported by the existing terminal. For example, the largest frequency bandwidth supported by the terminal is possibly 20 MHz or 40 MHz in FR 1 (Frequency range 1), or 50 MHz or 100 MHz in FR 2 (Frequency range 2).

For the RedCap terminal, for example. a BWP occupying a wider bandwidth than the bandwidth supported by the terminal is possibly allocated. For example, a BWP that occupies an 80 MHz bandwidth may be allocated to the RedCap terminal that supports 20 MHz. In this case, a base station (e.g., also referred to as gNB) can assign a signal to any of frequency resources in the 80 MHz BWP. Meanwhile, the frequency resource that can be simultaneously transmitted and received by the RedCap terminal is any 20 MHz in the 80 MHz BWP. For example. when the terminal performs transmission and reception in another frequency resource that differs from the resource of 20 MHz in which the terminal performs transmission and reception at a certain time, the terminal switches the frequency of the receiver. During switching the frequency of the receiver, the terminal is possibly incapable of transmitting and receiving a signal.

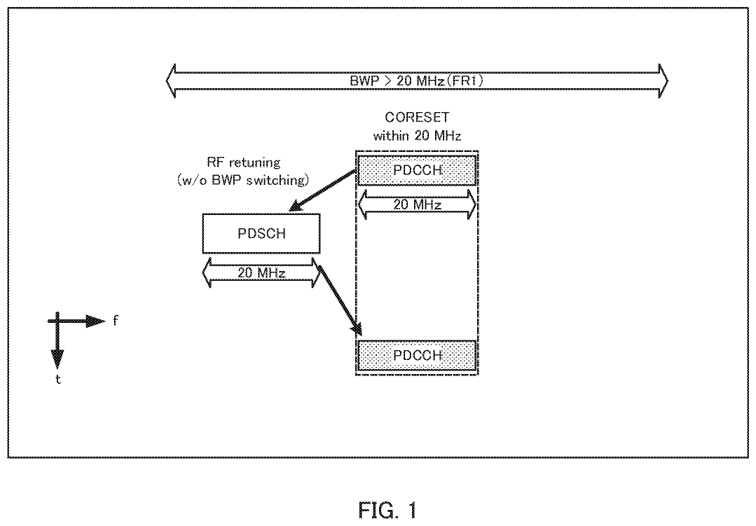

FIG. 1 illustrates exemplary switching of the frequency of the receiver in the terminal.

For example. the base station may map the first PDCCH to a certain frequency resource (e.g., a frequency resource of 20 MHz) based on the CORESET in the BWP (e.g., bandwidth wider than 20 MHz) allocated to the terminal. At this time, the data channel (e.g., Physical Downlink Shared Channel (PDSCH)) assigned by the first PDCCH is possibly mapped to another frequency resource that differs from the frequency resource for the first PDCCH. For example. as illustrated in FIG. 1, in a case where the frequency resource for the PDSCH is outside the frequency range that can be received by the terminal when the terminal receives the first PDCCH, the terminal switches (e.g., referred to as Radio Frequency (RF) retuning) the frequency of the receiver of the terminal in order to receive the PDSCH after receiving the first PDCCH. Further, as illustrated in FIG. 1, after receiving the PDSCH, the terminal switches the frequency of the receiver of the terminal again to receive the second PDCCH based on the CORESET.

During such frequency switching in the terminal, signal transmission and reception are not performed and a non-transmission interval occurs, which reduces the use efficiency of resources (e.g., time resources).

Thus, in an embodiment of the present disclosure, for example, a method for enhancing the use efficiency of resources in a terminal to which RedCap is applied will be described.

For example, in an embodiment of the present disclosure, after receiving a data signal (e.g., PDSCH) assigned by the first control signal (e.g., PDCCH), a terminal (e.g., a RedCap terminal) may receive the second control signal (PDCCH) in a frequency resource different from that of the first control signal. Accordingly, in the embodiment of the present disclosure, for example, the time of switching the frequency in the terminal (or the number of times of switching the frequency) is reduced, and thus the use efficiency of time resources can be enhanced.

Note that, in the following description, for example, the “first control signal (or first PDCCH)” may be a control signal (e.g., PDCCH) received by the terminal before the terminal switches the frequency. Further, the “second control signal (or second PDCCH)” may be a control signal (e.g., PDCCH) received by the terminal after the terminal switches the frequency. For example, the second PDCCH may be a control signal received by the terminal after reception of the data signal (e.g., PDSCH) assigned by the first PDCCH.

### [Overview of Communication System]

A communication system according to the present embodiment includes base station 100 and terminal 200.

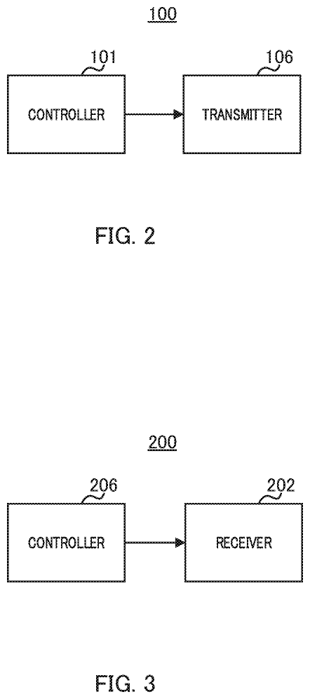

FIG. 2 is a block diagram illustrating an exemplary configuration of a part of base station 100 according to the present embodiment. In base station 100 illustrated in FIG. 2, controller 101 (e.g., corresponding to control circuitry) configures a frequency resource for the second control signal received by terminal 200 after terminal 200 receives the first control signal in the first frequency resource to be the second frequency resource including a frequency resource different from the first frequency resource. Transmitter 106 (e.g., corresponding to transmission circuitry) transmits the second control signal in the second frequency resource.

FIG. 3 is a block diagram illustrating an exemplary configuration of a part of terminal 200 according to the embodiment. In terminal 200 illustrated in FIG. 3, controller 206 (e.g., corresponding to control circuitry) configures a reception frequency resource for the second control signal (e.g., the second PDCCH) received after receiving the first control signal (e.g., first PDCCH) in the first frequency resource to be the second frequency resource including a frequency resource different from the first frequency resource. Receiver 202 (e.g., corresponding to reception circuitry) receives the second control signal in the second frequency resource.

### [Configuration of Base Station]

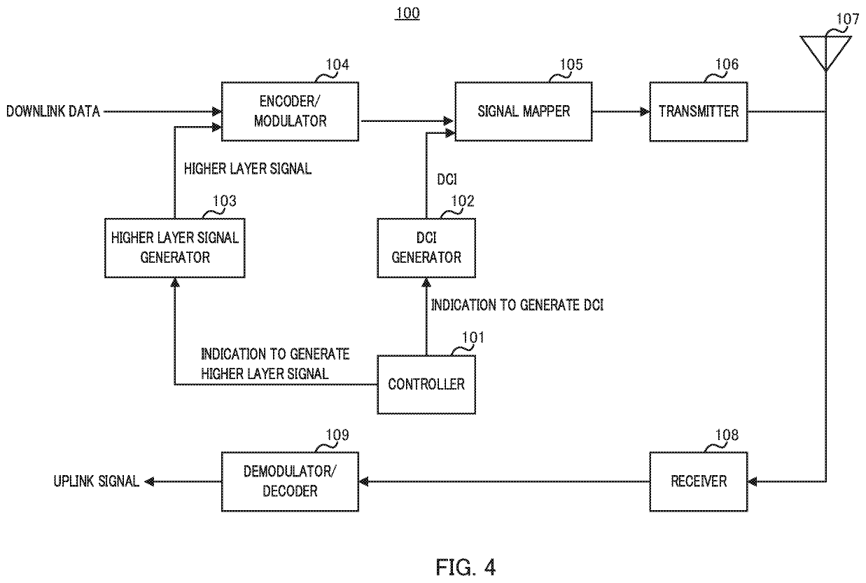

FIG. 4 is a block diagram illustrating an exemplary configuration of base station 100 according to the present embodiment. In FIG. 4. base station 100 includes controller 101, Downlink Control Information (DCI) generator 102, higher layer signal generator 103, encoder/modulator 104, signal mapper 105, transmitter 106, antenna 107, receiver 108, and demodulator/decoder 109.

For example, controller 101 may determine a parameter of a BWP to be configured in terminal 200. Further, for example, controller 101 may determine at least one of resources for a plurality of sub-bands obtained by dividing the BWP, a resource for a control channel (e.g., PDCCH), and a resource for a data channel (e.g., PDSCH). Controller 101 may indicate DCI generator 102 to generate downlink control information (e.g., DCI), and may indicate higher layer signal generator 103 to generate a higher layer signal (e.g., also referred to as a higher layer parameter or higher layer signaling), based on the determined parameter.

For example, DCI generator 102 may generate DCI based on an indication from controller 101 and output the generated DCI to signal mapper 105.

Higher layer signal generator 103 may generate a higher layer signal based on an indication from controller 101 and output the generated higher layer signal to encoder/modulator 104, for example.

Encoder/modulator 104 may, for example, perform error correction coding and modulation on the downlink data (e.g., PDSCH) and the higher layer signal input from higher layer signal generator 103, and output the modulated signal to signal mapper 105.

For example, signal mapper 105 may map the DCI input from DCI generator 102 and the signal input from encoder/modulator 104 to resources. For example, signal mapper 105 may map the signal input from encoder/modulator 104 to a PDSCH resource and map the DCI to a PDCCH resource. Signal mapper 105 outputs the signal mapped to each resource to transmitter 106.

For example, transmitter 106 performs radio transmission processing including frequency conversion (e.g., up-conversion) using a carrier wave on the signal input from signal mapper 105, and outputs the signal after the radio transmission processing to antenna 107.

Antenna 107 radiates a signal (e.g., a downlink signal) input from transmitter 106 toward terminal 200, for example. Further, antenna 107 receives an uplink signal transmitted from terminal 200, and outputs the uplink signal to receiver 108, for example.

The uplink signal may be, for example, a signal of a channel such as an uplink data channel (e.g., physical uplink shared channel (PUSCH)), uplink control channel (e.g., physical uplink control channel (PUCCH)), or random access channel (e.g., physical random access channel (PRACH)).

For example, receiver 108 performs radio reception processing including frequency conversion (e.g., down-conversion) on the signal input from antenna 107, and outputs the signal after the radio reception processing to demodulator/decoder 109.

For example, demodulator/decoder 109 demodulates and decodes the signal input from receiver 108, and outputs the uplink signal.

### [Configuration of Terminal]

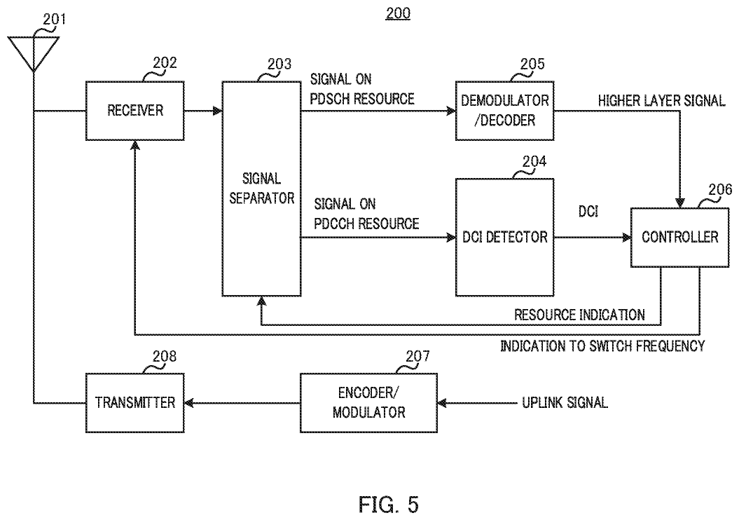

FIG. 5 is a block diagram illustrating an exemplary configuration of terminal 200 according to the present embodiment.

In FIG. 5, terminal 200 includes antenna 201, receiver 202, signal separator 203, DCI detector 204, demodulator/decoder 205, controller 206. encoder/modulator 207, and transmitter 208.

Antenna 201 receives a downlink signal transmitted by base station 100, and outputs the downlink signal to receiver 202. In addition, antenna 201 radiates an uplink signal input from transmitter 208 to base station 100.

For example, receiver 202 performs radio reception processing including frequency conversion (e.g., down-conversion) on the signal input from antenna 201, and outputs the signal after the radio reception processing to signal separator 203. For example, receiver 202 may switch the reception frequency in accordance with an indication for frequency switching input from controller 206. For example, receiver 202 may adjust by switching the reception frequency so that a data channel (e.g., PDSCH) can be received.

Signal separator 203 may identify a resource for each channel or signal based on at least one of pre-defined or pre-configured information and an indication on the resource input from controller 206, for example. For example, signal separator 203 extracts (in other words, separates) a signal mapped to the identified PDCCH resource, and outputs the signal to DCI detector 204. Further, signal separator 203 outputs, for example, a signal mapped to the identified PDSCH resource to demodulator/decoder 205.

For example, DCI detector 204 may detect DCI from the signal (e.g., signal on the PDCCH resource) input from signal separator 203. DCI detector 204 may output the detected DCI to controller 206, for example.

For example, demodulator/decoder 205 performs demodulation and error correction decoding on the signal (e.g., signal on the PDSCH resource) input from signal separator 203, and obtains at least one of downlink data and a higher layer signal. For example, demodulator/decoder 205 may output the higher layer signal obtained by decoding to controller 206.

For example, controller 206 may identify a PDSCH resource based on the DCI input from DCI detector 204 and output (in other words, indicate) information on the identified PDSCH resource to signal separator 203. For example, when the frequency resource for the PDSCH is outside the range of the frequency resource that can be currently received by receiver 202, controller 206 may output information on frequency switching to receiver 202.

Further, for example, controller 206 may identify a parameter of a BWP or a resource for a sub-band to be configured in terminal 200 and configure the BWP or the sub-band based on at least one of the DCI input from DCI detector 204 and the higher layer signal input from demodulator/decoder 205.

Encoder/modulator 207 may, for example, perform encoding and modulation on an uplink signal (e.g., PUSCH, PUCCH or PRACH) and output the modulated signal to transmitter 208.

Transmitter 208 performs radio transmission processing including frequency conversion (e.g., up-conversion) on the signal input from encoder/modulator 207, and outputs the signal after the radio transmission processing to antenna 201, for example.

### [Exemplary Operation of Base Station 100 and Terminal 200]

Next, an exemplary operation of base station 100 and terminal 200 described above will be described.

### OPERATION EXAMPLE 1

In Operation Example 1, for example, base station 100 and terminal 200 may determine a reception frequency resource for the second control signal based on a frequency resource to which a data signal assigned by the first control signal is assigned.

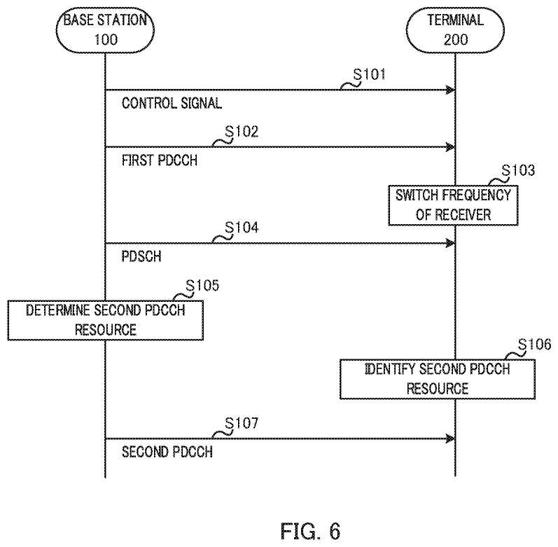

FIG. 6 is a sequence diagram illustrating an exemplary operation of base station 100 and terminal 200.

### S101

For example, base station 100 may determine a parameter value of one or a plurality of BWPs allocated to terminal 200. The parameter of the BWP may include at least a bandwidth of the BWP, for example. The bandwidth of the BWP may be, for example, a bandwidth wider than the bandwidth supported by terminal 200. Note that the bandwidth supported by terminal 200 may be reported in advance from terminal 200 to base station 100, for example.

For example, base station 100 may allocate a BWP whose bandwidth is “80 MHz” to terminal 200 that has reported in advance that the supported bandwidth is “20 MHz”. Note that the bandwidth supported by terminal 200 and the bandwidth of the BWP are not limited to these values, and may be other values. Further, the BWP may be configured to have a bandwidth equal to or less than the bandwidth supported by terminal 200.

Base station 100 may transmit, to terminal 200, a control signal including information on the determined parameter of the BWP. Note that the control signal may include information on an indication to activate the BWP (e.g., BWP occupying a bandwidth wider than the bandwidth supported by terminal 200), for example.

Terminal 200 may, for example, receive the control signal from base station 100, identify the parameter of the BWP based on the received control signal, and configure the BWP based on the identified parameter. Further, terminal 200 may activate the BWP (e.g., BWP occupying a bandwidth wider than the bandwidth supported by terminal 200) based on the control signal from base station 100, for example.

### S102

Base station 100 may map DCI to the first PDCCH and transmit the first PDCCH. The DCI may include, for example, PDSCH assignment data. For example, base station 100 may allocate a frequency resource for the PDSCH to the outside the range of the frequency that can be received by terminal 200 when terminal 200 receives the first PDCCH (e.g., frequency resource in which the first PDCCH is transmitted).

For example, terminal 200 may receive the first PDCCH transmitted from base station 100 and obtain (or extract or detect) the DCI included in the first PDCCH.

Note that base station 100 and terminal 200 may determine or identify a frequency resource for the PDCCH based on a CORESET associated with the BWP, for example. Alternatively, base station 100 and terminal 200 may determine or identify the frequency resource for the PDCCH based on a signal (e.g., PDCCH or PDSCH) transmitted at a time prior to transmission of the first PDCCH, for example.

### S103

When the frequency resource for the PDSCH assigned by the DCI is outside the range of the frequency resource that can be received at the time when terminal 200 receives the first PDCCH, terminal 200 may switch the frequency of receiver 202 of terminal 200.

Note that, for example, when the frequency resource for the PDSCH is included in the active BWP, terminal 200 need not switch the active BWP. In other words, when the frequency resource for the PDSCH is included in the active BWP, terminal 200 may switch the frequency of the receiver without switching the BWP.

### S104

Base station 100 may, for example, map a signal to the PDSCH based on the assignment information on the PDSCH, and transmit the PDSCH. Terminal 200 may receive the signal on the PDSCH based on the assignment information on the PDSCH, for example.

### S105

Base station 100 may, for example, determine a frequency resource for the second PDCCH. For example, base station 100 may determine the frequency resource for the second PDCCH that is transmitted after the PDSCH, based on the frequency resource for the PDSCH assigned by the first PDCCH. For example, base station 100 may determine the frequency resource for the second PDCCH to be any of the frequency resources within the frequency range that can be received by terminal 200 when terminal 200 receives the PDSCH. For example, the frequency resource for the second PDCCH may be different from the frequency resource for the first PDCCH.

### S106

Terminal 200 may, for example, identify (or determine) the frequency resource for the second PDCCH, similarly to the processing performed by base station 100 in S105. For example, terminal 200 may determine the frequency resource for the second PDCCH that is received after the PDSCH, based on the frequency resource for the PDSCH assigned by the first PDCCH.

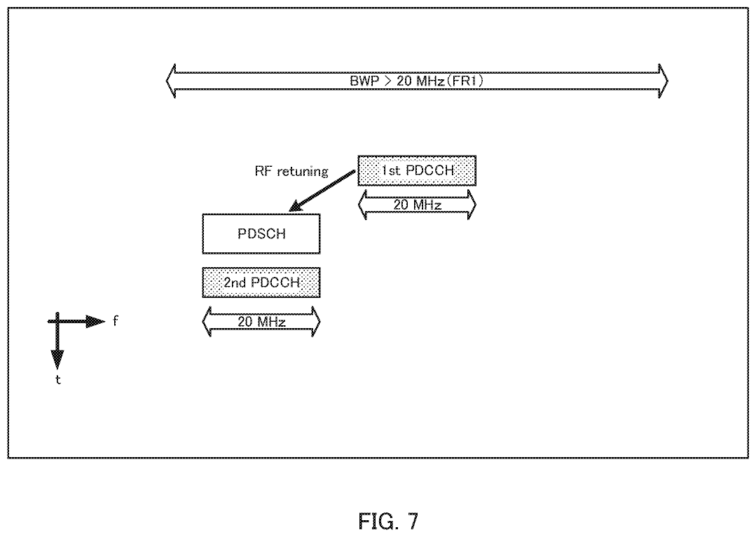

FIG. 7 illustrates exemplary frequency switching of receiver 202 in terminal 200.

In FIG. 7, for example, base station 100 maps the first PDCCH to a certain frequency resource (e.g., frequency resource of 20 MHz) within the BWP (e.g., bandwidth wider than 20 MHz) allocated to terminal 200. Further, in FIG. 7, base station 100 maps the PDSCH assigned by the first PDCCH to another frequency resource different from the frequency resource for the first PDCCH.

In this case, as illustrated in FIG. 7. terminal 200 switches (e.g., RF retuning) the frequency of receiver 202 of terminal 200 in order to receive the PDSCH, after receiving the first PDCCH, for example.

Further, in the processes of S10S and S106 in FIG. 6, base station 100 and terminal 200 may determine or identify the frequency resource (e.g., frequency position) of the second PDCCH based on the frequency resource (or frequency position) of the PDSCH.

For example, base station 100 and terminal 200 may configure a center frequency (e.g., center resource block (RB: Resource Block)) of the frequency resource for the PDSCH to be the same as a center frequency (e.g., center RB) of the frequency resource for the second PDCCH. Note that the frequency position (e.g., the reference) used for determining the frequency resource for the second PDCCH is not limited to the center RB, and may be, for example, any one of the smallest, the middle, or the largest value in the RB or the index of the subcarrier occupied by the PDSCH.

Alternatively, base station 100 and terminal 200 may determine or identify the frequency position of the second PDCCH. for example, based on the frequency position obtained by shifting a CORESET associated with the BWP in the frequency direction. Alternatively, base station 100 and terminal 200 may determine or identify the frequency position of the second PDCCH, for example, based on the frequency position obtained by shifting the frequency position of the first PDCCH. For example. base station 100 and terminal 200 may determine the frequency position of the second PDCCH based on the frequency resource for the PDSCH as described above, and may determine a configuration of the second PDCCH (e.g., a parameter different from the frequency position, such as an aggregation level) based on the CORESET associated with the BWP or the configuration of the first PDCCH.

Alternatively, the frequency resource for the second PDCCH may be determined by base station 100, for example, and the information on the determined frequency resource may be indicated in advance to terminal 200 with a control signal.

### S107

In FIG. 6, base station 100 may map DCI to the second PDCCH based on the determined frequency resource, and transmit the second PDCCH. Further, terminal 200 may, for example, receive the second PDCCH transmitted from base station 100 based on the identified frequency resource, and obtain (or extract or detect) the DCI included in the second PDCCH.

For example, as illustrated in FIG. 7. terminal 200 may receive the second PDCCH within the range of the frequency resource in which terminal 200 has received the PDSCH. In other words, terminal 200 may receive the second PDCCH without switching the frequency in which terminal 200 has received the PDSCH.

As described above, in Operation Example 1, terminal 200 need not switch the frequency of receiver 202 after receiving the PDSCH until receiving the second PDCCH. Therefore, according to Operation Example 1, the number of times of switching the frequency of receiver 202 of terminal 200 can be reduced, and thus a non-transmission interval caused by the frequency switching of receiver 202 can be reduced, which can enhance the use efficiency of time resources.

Further, in Operation Example 1, for example, terminal 200 can identify the frequency resource for the second PDCCH based on the frequency resource for the PDSCH, so that the indication of the control signal on the frequency resource for the second PDCCH can be reduced, which suppresses an increase in overhead of the control signal.

### Operation Example 2

In Operation Example 2, for example, the BWP may be divided into a plurality of sub-bands, and a control signal may be transmitted and received in at least two sub-bands (e.g., the first sub-band and the second sub-band) among the plurality of sub-bands.

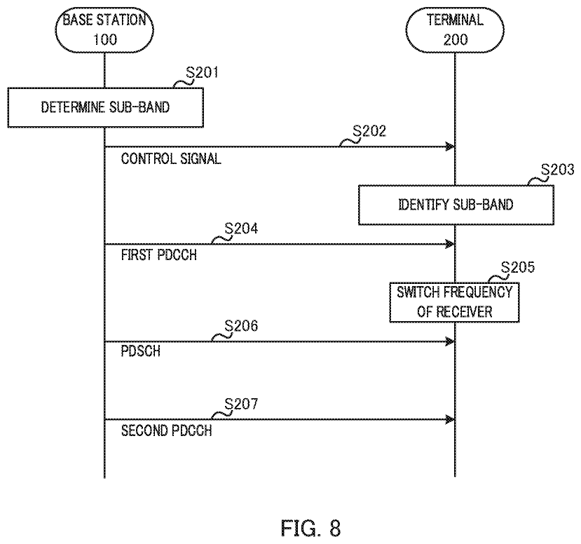

FIG. 8 is a sequence diagram illustrating exemplary processing of base station 100 and terminal 200.

### S201

For example, base station 100 may determine a parameter value of one or a plurality of BWPs allocated to terminal 200. The parameter of the BWP may include at least a bandwidth of the BWP, for example. The bandwidth of the BWP may be, for example, a bandwidth wider than the bandwidth supported by terminal 200. Note that the bandwidth supported by terminal 200 may be reported in advance from terminal 200 to base station 100, for example.

For example, base station 100 may allocate a BWP whose bandwidth is “80 MHz” to terminal 200 that has reported in advance that the supported bandwidth is “20 MHz”. Note that the bandwidth supported by terminal 200 and the bandwidth of the BWP are not limited to these values, and may be other values. Further, the BWP may be configured to be equal to or less than the bandwidth supported by terminal 200.

Furthermore, base station 100 may determine, for example, a plurality of sub-bands associated with the BWP allocated to terminal 200. In this case, the frequency resource for each sub-band may be within the BWP (in other words, need not be outside the BWP), for example. Further, the bandwidth of each sub-band may be, for example, equal to or less than the bandwidth supported by terminal 200. In addition, the bandwidths of the plurality of sub-bands may be common or different from one another, for example.

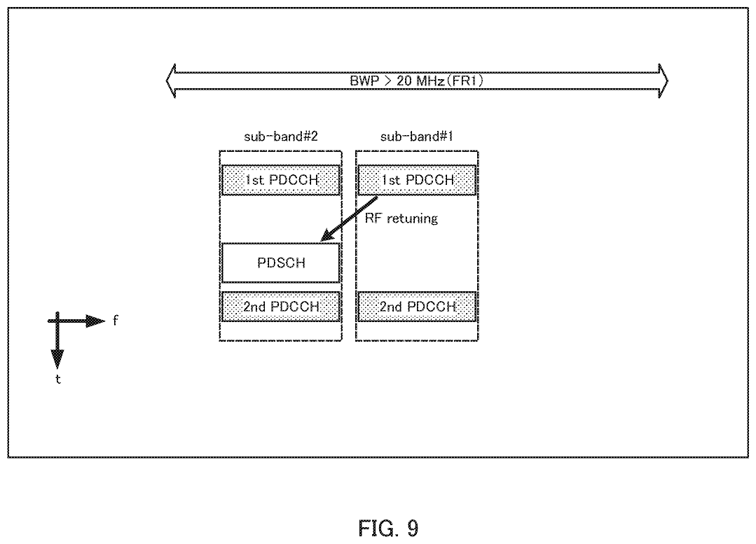

FIG. 9 illustrates an exemplary BWP and sub-bands configured in terminal 200. In FIG. 9, for example, base station 100 configures at least the first sub-band (sub-band #1) and the second sub-band (sub-band #2) within the BWP (e.g., bandwidth wider than 20 MHz) allocated to terminal 200.

### S202

Base station 100 may transmit, to terminal 200, a control signal including information on the determined parameter of the BWP. Note that the control signal may include information on an indication to activate the BWP (e.g., BWP occupying a bandwidth wider than the bandwidth supported by terminal 200), for example. Further, the control signal may include, for example, information on the sub-bands.

Terminal 200 receives the control signal from base station 100, for example.

### S203

Terminal 200 may identify the parameter of the BWP based on the received control signal, and configure the BWP based on the identified parameter. Further, terminal 200 may identify. for example, the configuration of sub-bands obtained by dividing the BWP based on the received control signal.

In addition, terminal 200 may activate the BWP (e.g., BWP occupying a bandwidth wider than the bandwidth supported by terminal 200) based on the received control signal, for example.

### S204

Base station 100 may map DCI to the first PDCCH and transmit the first PDCCH. For example, base station 100 may configure the first PDCCH resource in the first sub-band and the second sub-band among the plurality of sub-bands. For example, the first sub-band may be a resource within a frequency range that can be currently received by terminal 200, and the second sub-band may be a resource outside the frequency range that can be currently received by the terminal.

Further, the DCI mapped to the first PDCCH may include, for example, PDSCH assignment data. The resource to which the PDSCH is assigned may be, for example, a resource in the second sub-band.

For example, terminal 200 may receive the first PDCCH transmitted from base station 100 and obtain (or extract or detect) the DCI included in the first PDCCH. In the example illustrated in FIG. 9, terminal 200 receives the first PDCCH in the first sub-band, for example.

### S205

When the frequency resource for the PDSCH assigned by the DCI is outside the range of the frequency resource that can be received by terminal 200 at the time when terminal 200 receives the first PDCCH, terminal 200 may switch the frequency of receiver 202 of terminal 200. In the example illustrated in FIG. 9. terminal 200 switches (e.g., RF retuning) the frequency of receiver 202 of terminal 200 from the first sub-band to the second sub-band in order to receive the PDSCH, after receiving the first PDCCH in the first sub-band, for example.

Note that, for example, when the frequency resource for the PDSCH is included in the active BWP, terminal 200 need not switch the active BWP. In other words, when the frequency resource for the PDSCH is included in the active BWP, terminal 200 may switch the frequency of the receiver without switching the BWP.

Further, for example, when failing to receive the first PDCCH, terminal 200 need not perform frequency switching.

### S206

Base station 100 may, for example, map a signal to the PDSCH based on the assignment information on the PDSCH, and transmit the PDSCH. Terminal 200 may receive the signal on the PDSCH based on the assignment information on the PDSCH, for example.

### S207

Base station 100 may map DCI to the second PDCCH and transmit the second PDCCH. For example, base station 100 may configure the second PDCCH resource in the first sub-band and the second sub-band among the plurality of sub-bands.

Terminal 200 may receive, for example, the second PDCCH transmitted from base station 100 in any one of the first sub-band and the second sub-band among the plurality of sub-bands. For example, when performing frequency switching (e.g., switching from the first sub-band to the second sub-band) in the process of S205, terminal 200 may receive the second PDCCH in the second sub-band. On the other hand, for example, when not performing frequency switching (e.g., switching from the first sub-band to the second sub-band) in the process of S205, terminal 200 may receive the second PDCCH in the first sub-band.

In FIG. 9, terminal 200 performs frequency switching (RF retuning) from the first sub-band to the second sub-band when receiving the PDSCH. and thus receives the second PDCCH in the second sub-band after the switching.

As described above. in Operation Example 2, since the PDCCH is mapped to a plurality of sub-bands in the BWP, terminal 200 can receive the PDCCH in a sub-band within the frequency range that can be received by terminal 200, regardless of whether the frequency switching is performed. Therefore, for example, by receiving, after receiving the PDSCH, the second PDCCH in the sub-band within the same frequency range as the PDSCH, terminal 200 need not switch the frequency of receiver 202 until receiving the second PDCCH. Thus, according to Operation Example 2, the number of times of switching the frequency of receiver 202 of terminal 200 can be reduced, and therefore, a non-transmission interval caused by the frequency switching of receiver 202 can be reduced, which can enhance the use efficiency of time resources.

Further, in Operation Example 2, for example, terminal 200 may determine to receive the second PDCCH in a sub-band corresponding to the allocation band of the first PDCCH when terminal 200 fails to receive the first PDCCH in the first sub-band and the second sub-band, and may determine to receive the second PDCCH in a sub-band different from the sub-band corresponding to the allocation band of the first PDCCH when terminal 200 successfully receives the first PDCCH. This reception control allows terminal 200 to receive the second PDCCH in the reception band of the first PDCCH, for example, even when the reception of the first PDCCH fails. Therefore, according to Operation Example 2, for example, as compared with Operation Example 1, terminal 200 is more likely to receive the control signal, which allows a more stable operation.

Note that, in Operation Example 2, the PDCCH configured in a plurality of sub-bands may be a channel obtained by shifting the PDCCH mapped to a certain sub-band in the frequency domain. Further. the information included in the DCI mapped to the PDCCH in each of the plurality of sub-bands may be the same information or may be different between the sub-bands.

Further, in Operation Example 2, the frequency resources occupied by the sub-bands may be configured so as not to overlap each other. Accordingly, collisions between the PDCCHs in the respective sub-bands can be avoided, and thus the probability of failure of decoding PDCCHs in terminal 200 can be reduced (in other words, the probability of success of decoding PDCCHs can be increased).

In addition, in Operation Example 2, a case has been described in which the PDSCH is transmitted in one sub-band, but the present disclosure is not limited thereto, and the PDSCH may be transmitted in a plurality of sub-bands.

Further, in Operation Example 2, a case has been exemplarily described in which the first PDCCH is assigned to a plurality of sub-bands, but the present disclosure is not limited thereto, and the frequency resource allocated to the first PDCCH may be configured in one of a plurality of sub-bands (e.g., in FIG. 9, the first sub-band), and the frequency resource allocated to the second PDCCH may be configured in a plurality of sub-bands (e.g., the first sub-band and the second sub-band).

Furthermore, in Operation Example 2, the resources (e.g., sub-bands) to which the first PDCCH and the second PDCCH are mapped may be periodically different from each other.

In addition, the number of sub-bands described in Operation Example 2 is merely an example, and is not limited thereto. Further, the PDCCH (e.g., at least one of the first PDCCH and the second PDCCH) may be mapped to some sub-bands among the plurality of sub-bands configured in terminal 200 and need not be mapped to the remaining sub-bands. Alternatively, the PDCCH (e.g., at least one of the first PDCCH and the second PDCCH) may be mapped to all configured sub-bands.

The exemplary operation of base station 100 and terminal 200 has been described above.

As described above, in the present embodiment, base station 100 and terminal 200 configure a reception frequency resource for the second PDCCH received by terminal 200 after terminal 200 receives the first PDCCH in the first frequency resource to be the second frequency resource including a frequency resource different from the above-described first frequency resource. For example, in Operation Example 1, the frequency resource for the second PDCCH may be configured based on the frequency resource to which the data signal is assigned. Further, for example, in Operation Example 2, the frequency resource for the second PDCCH may be configured in a plurality of sub-bands.

Thus, terminal 200 can receive the first PDCCH and the second PDCCH at different frequency resources, for example. This increases the probability that terminal 200 need not perform frequency switching (RF retuning) to receive the second PDCCH after receiving the data signal assigned by the first PDCCH, for example. Therefore, according to the present embodiment, terminal 200 can reduce the number of times of frequency switching (RF retuning) of receiver 202, and thus can reduce the occurrence of a non-transmission interval due to frequency switching, which can enhance the use efficiency of time resources.

The embodiment of the present disclosure has been described above.

### OTHER EMBODIMENTS

### Combination of Operation Example 1 and Operation Example 2

Operation Example 1 and Operation Example 2 may be combined. For example, in some frequency resources in the BWP configured in terminal 200. base station 100 and terminal 200 may configure a reception frequency resource for the second PDCCH based on the frequency resource for the PDSCH assigned by the first PDCCH, as in Operation Example 1. Further, for example, in other frequency resources in the BWP configured in terminal 200, base station 100 and terminal 200 may configure frequency resources for PDCCHs (e.g., the first PDCCH and the second PDCCH) in a plurality of sub-bands, as in Operation Example 2.

By combining Operation Example 1 and Operation Example 2, the flexibility of allocating a PDCCH and a PDSCH in the BWP can be enhanced.

### (Collision Between PDCCH and PDSCH)

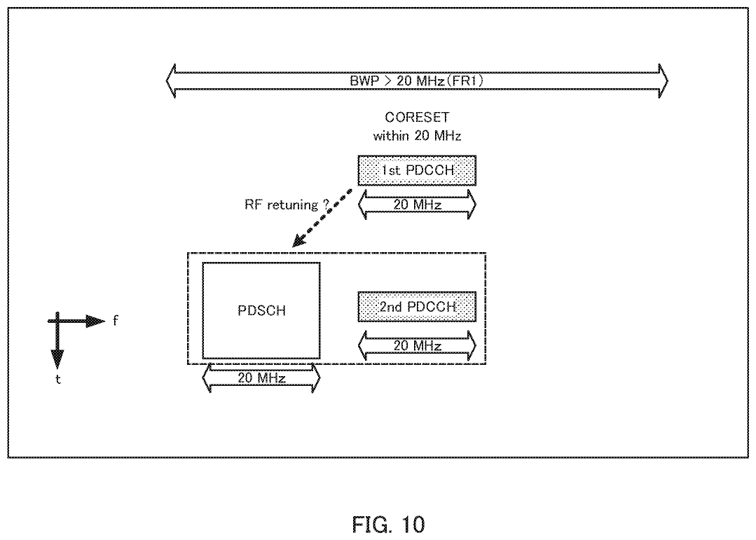

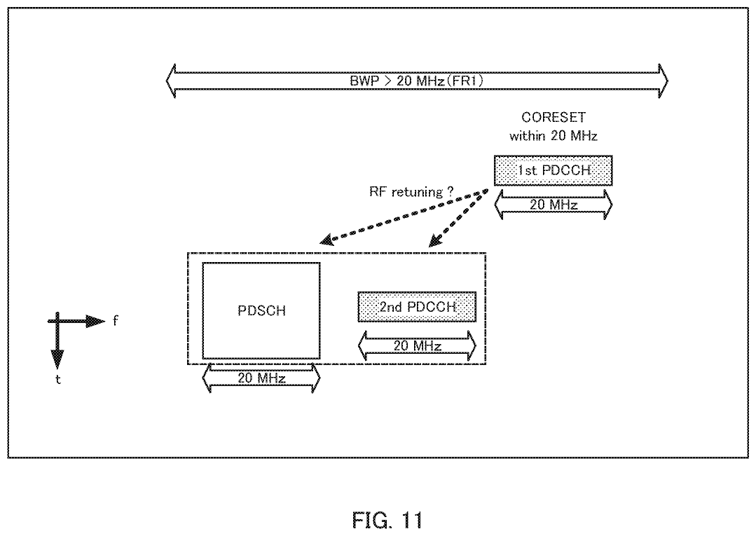

In the above embodiment, as illustrated in FIGS. 10 and 11, base station 100 possibly assigns the PDSCH assigned by the first PDCCH at the same time (or the same transmission and reception timing) as that of the second PDCCH, for example. FIG. 10 illustrates an example in which a frequency resource to which the first PDCCH is mapped and a frequency recourse to which the second PDCCH is mapped are the same, and FIG. 11 illustrates an example in which a frequency resource to which the first PDCCH is mapped and a frequency resource to which the second PDCCH is mapped are different with each other.

In this case, terminal 200 may be capable of receiving either one of the second PDCCH and the PDSCH. For example, terminal 200 may determine to switch the reception frequency from the frequency resource in which terminal 200 has received the first PDCCH to either one of the allocated frequency resource for the second PDCCH and the allocated frequency resource for the PDSCH.

For example, in FIG. 10, terminal 200 may determine which signal terminal 200 receives (in other word, which signal is prioritized or whether RF retuning is performed) based on the following (1), (2), and (3).

(1) Terminal 200 may receive the second PDCCH.

(2) Terminal 200 may receive a PDSCH.

(3) Terminal 200 may select reception of the second PDCCH or the PDSCH according to a certain criteria. For example, terminal 200 may receive the PDSCH when rate-matching is not indicated and receive the second PDCCH when rate-matching is indicated. Alternatively, terminal 200 may receive the second PDCCH when the second PDCCH is included in Common Search Space (CSS) and receive the PDSCH when the second PDCCH is included in UE-specific Search Space (USS).

In other words, when reception timing of the PDSCH assigned by the first PDCCH and the second PDCCH is the same. terminal 200 may determine to switch the reception frequency from the reception frequency of the first PDCCH to either one of the allocated frequency resource for the PDSCH and the allocated frequency resource for the second PDCCH, based on at least one of a signal type (e.g., type of a data signal, control signal, or search space) and a process on a signal (e.g., whether rate-matching is performed).

For example, in FIG. 10, terminal 200 does not switch the frequency of the receiver when determining to receive the second PDCCH, and switches the frequency of the receiver when determining to receive the PDSCH. Further, for example, in FIG. 11, in both of the cases of determining to receive the second PDCCH and determining to receive the PDSCH, terminal 200 switches the frequency of the receiver to a frequency resource corresponding to a reception signal (either the second PDCCH or the PDSCH).

### (Default Sub-Band)

In the above embodiment, one sub-band among a plurality of sub-bands may be configured to be a “default sub-band”. For example, when a condition of passing a certain period of time is satisfied, terminal 200 may switch (or fallback) the frequency of receiver 202 from another sub-band to the default sub-band so that terminal 200 can receive a signal on the default sub-band.

For example, a signal of PDCCH CSS may be transmitted in the default sub-band. This increases the probability that terminal 200 can receive a PDCCH CSS signal, which allows a more stable operation.

Further, for example, a synchronization signal such as Synchronization Signal Block (SSB) or a referencing signal may be transmitted in the default sub-band. This increases the probability that terminal 200 can receive a synchronization signal or a reference signal, which allows a more stable operation.

### (BWP Switching)

In the above-described embodiments, terminal 200 may activate another BWP that differs from the active BWP in accordance with an indication or the like from base station 100, for example. In other words, terminal 200 may switch the active BWP. This BWP switching (e.g., also referred to as retuning) may be switching between simplified BWPs or switching between a simplified BWP and a normal BWP.

Further, in the BWP switching, a time resource before and after the switching timing may be configured in a guard period (the name is exemplary), and transmission and reception of a signal assigned to the resource may be omitted. For example, in a case of switching from BWP #1 to BWP #2, transmission and reception of signals in several symbols or a slot immediately before the switching in BWP #1 may be omitted, or transmission and reception of signals in several symbols or a slot immediately after the switching in BWP #2 may be omitted. Alternatively, signals in both the time resource immediately before the switching in BWP #1 and the time resource immediately after the switching in BWP #2 may be omitted.

In the above-described BWP switching, a signal to be omitted (e.g., BWP in which a signal is to be omitted) may be determined according to some criteria. For example, transmission and reception of a signal satisfying at least one of the following criterion may be omitted.

(1) A data signal, a control signal (e.g., signal of common search space or UE-specific search space), or a reference signal

(2) A downlink signal or an uplink signal

(3) An orthogonal sequence (e.g., Orthogonal Cover Code (OCC)) is not applicable

For example, in a case where the signals before or after the BWP switching are a downlink control signal and a downlink data signal, transmission and reception of the downlink data signal may be omitted when the control signal is a signal in Common search space, and transmission and reception of the downlink control signal may be omitted when the control signal is a signal in UE-specific search space. This allows transmission and reception of a signal having high importance without omitting it. Note that an exemplary configuration of the importance (or priority) between signal types (e.g., a data signal, a control signal, or a reference signal) is not limited to the above example.

Further, in the BWP switching, for example, a control signal and a data signal may be assigned to a time resource different from the guard period described above. In this case, rate-matching may be applied to the control signal and the data signal. Further, for example, the application of rate-matching may be indicated to terminal 200. Further, for example, base station 100 may configure search space so as to assign a downlink signal to a time resource different from the guard period, or terminal 200 may determine that a time resource to which the control signal is assigned has been shifted.

### (Terminal Type and Identification)

The above-described embodiments may be applied to, for example, a “RedCap terminal” or a non RedCap terminal.

Note that the RedCap terminal may be, for example, a terminal having at least one of the following characteristics (in other words, attributes or capabilities).

(1) A terminal that indicates (e.g., report), to base station 100, that the terminal is “a terminal targeted for coverage enhancement”, “a terminal that receives a signal repeatedly transmitted”, or “a RedCap terminal”. Note that, for the above-described indication (report), an uplink channel such as a PRACH and a PUSCH or an uplink signal such as a Sounding Reference Signal (SRS) may be used, for example.

(2) A terminal having at least one of the following capabilities, or a terminal reporting at least one of the following capabilities to base station 100. Note that, for the above-described report, an uplink channel such as a PRACH and a PUSCH or an uplink signal such as a UCI or an SRS may be used, for example.
A terminal whose supportable frequency bandwidth is equal to or less than a threshold value (e.g., 20 MHz, 40 MHz, or 100 MHz)
A terminal in which the number of implemented reception antennae is equal to or less than a threshold value (e.g., threshold=1)
A terminal in which the number of supportable downlink ports (e.g., the number of reception antenna ports) is equal to or less than a threshold value (e.g., threshold value=2)
A terminal in which the number of supportable number of transmission ranks (e.g., the number of maximum Multiple-Input Multiple-Output (MIMO) layers (or the number of ranks) is equal to or less than a threshold value (e.g., threshold value=2)
A terminal capable of transmitting and receiving a signal in a frequency band equal to or higher than a threshold value (e.g., Frequency Range 2 (FR2) or a band equal to or higher than 52 GHz)
A terminal whose processing time is equal to or longer than a threshold value
A terminal in which the available transport block size (TBS) is equal to or less than a threshold value
A terminal in which the number of available transmission ranks (e.g., the number of MIMO transmission layers) is equal to or less than a threshold value.
A terminal whose available modulation order is equal to or less than a threshold value
A terminal in which the number of available Hybrid Automatic Repeat request (HARQ) processes is equal to or less than a threshold value
A terminal that supports Rel-17 NR or later release

(3) A terminal to which a parameter corresponding to a RedCap mobile station is indicated from base station 100. Note that the parameter corresponding to the RedCap mobile station may include, for example, a parameter such as a Subscriber Profile ID for RAT/Frequency Priority (SPID).

Note that the “non RedCap terminal” may mean, for example, a terminal that supports Rel-15/16 (e.g., a terminal that does not support Rel-17) or a terminal that does not have the above-described characteristics even though the terminal supports Rel-17.

### (Type of BWP)

In the above-described embodiments, the bandwidth of the BWP is wider than the bandwidth supported by terminal 200, but the present disclosure is not limited thereto, and the bandwidth of the BWP may be equal to or smaller than the bandwidth supported by terminal 200.

### (Signal/Channel Type)

Note that, in the above-described embodiments, the downlink channel and signal (e.g., a PDCCH and a PDSCH) have been described, but the above-described embodiments may be applied to an uplink channel and signal (e.g., any of a PUCCH, a PUSCH and a PRACH). For example, an example has been described in which the downlink data signal (e.g., PDSCH) is assigned by the PDCCH, but an uplink data signal (e.g., PUSCH) may be assigned by the PDCCH.

Further, in the above embodiments, an example has been described in which the resource for the data signal (e.g., PDSCH or PUSCH) is assigned to terminal 200 by the PDCCH (e.g., downlink control information), but the present disclosure is not limited thereto, and may be configured by a higher layer signal, for example.

Furthermore, the PDCCH may be transmitted, for example, in either Common Search Space (CSS) or UE Specific Search Space (USS).

Further, any component termed with a suffix, such as “-er,” “-or,” or “-ar” in the above-described embodiments may be replaced with other terms such as “circuit (circuitry),” “device,” “unit,” or “module.”

### (Supplement)

Information indicating whether terminal 200 supports the functions, operations, or processes described in the above-described embodiments may be transmitted (or indicated) from terminal 200 to base station 100 as capability information or a capability parameter of terminal 200.

The capability information may include an information element (IE) individually indicating whether terminal 200 supports at least one of the functions, operations, or processes described in the above-described embodiments. Alternatively, the capability information may include an information element indicating whether terminal 200 supports a combination of any two or more of the functions, operations, or processes described in the above-described embodiments, modifications, and supplements.

Base station 100 may determine (or assume) the function, operation, or process supported (or not supported) by terminal 200 of the transmission source of the capability information, based on the capability information received from terminal 200, for example. Base station 100 may perform an operation. processing, or control corresponding to a determination result based on the capability information. For example. base station 100 may control the allocation (in other words, scheduling) of at least one of a downlink resource such as a PDCCH or PDSCH and an uplink resource such as a PUCCH or a PUSCH, based on the capability information received by terminal 200.

Note that the fact that terminal 200 does not support some of the functions, operations, or processes described in the above-described embodiments may be read as that some of the functions. operations, or processes are limited in terminal 200. For example, information or a request on such limitation may be indicated to base station 100.

Information on the capability or limitation of terminal 200 may be defined, for example, in the standard, or may be implicitly indicated to base station 100 in association with information known to base station 100 or information transmitted to base station 100.

### (Control Signal)

In the present disclosure, the downlink control signal (or downlink control information) relating to the exemplary embodiment of the present disclosure may be a signal (or information) transmitted in a Physical Downlink Control Channel (PDCCH) in a physical layer, for example, or may be a signal (or information) transmitted in a Medium Access Control Control Element (MAC CE) or Radio Resource Control (RRC) in a higher layer. Further, the signal (or information) is not limited to that indicated by the downlink control signal, but may be predefined in the specifications (or standard) or may be pre-configured for the base station and the terminal.

In the present disclosure. the uplink control signal (or uplink control information) relating to the exemplary embodiment of the present disclosure may be, for example, a signal (or information) transmitted in a PUCCH of the physical layer or a signal (or information) transmitted in the MAC CE or RRC of the higher layer. In addition, the signal (or information) is not limited to a case of being indicated by the uplink control signal and may be previously specified by the specifications (or standards) or may be previously configured in a base station and a terminal. Further, the uplink control signal may be replaced with, for example, uplink control information (UCI), 1st stage sidelink control information (SCI), or 2nd stage SCI.

### (Base Station)

In the above embodiments, the base station may be a transmission reception point (TRP), a clusterhead, an access point, a remote radio head (RRH), an eNodeB (eNB), a gNodeB (gNB), a base station (BS), a base transceiver station (BTS), a base unit, or a gateway, for example. Further. in side link communication, a terminal may play a role of a base station. Furthermore, instead of the base station, a relay apparatus that relays communication between a higher node and a terminal may be used. Moreover, a road side device may be used.

### (Uplink/Downlink/Sidelink)

An exemplary embodiment of the present disclosure may be applied to, for example, any of an uplink, a downlink, and a sidelink. For example, an exemplary embodiment of the present disclosure may be applied to an uplink Physical Uplink Shared Channel (PUSCH), Physical Uplink Control Channel (PUCCH), or Physical Random Access Channel (PRACH), a downlink Physical Downlink Shared Channel (PDSCH), PDCCH, or Physical Broadcast Channel (PBCH), or a sidelink Physical Sidelink Shared Channel (PSSCH), Physical Sidelink Control Channel (PSCCH), or Physical Sidelink Broadcast Channel (PSBCH).

Note that the PDCCH. the PDSCH, the PUSCH, and the PUCCH are examples of a downlink control channel, a downlink data channel. an uplink data channel, and an uplink control channel. respectively. Further, the PSCCH and the PSSCH are examples of a side link control channel and a side link data channel, respectively. Further, the PBCH and PSBCH are examples of a broadcast channel, and the PRACH is an example of a random access channel.

### (Data Channel/Control Channel)

An exemplary embodiment of the present disclosure may be applied to, for example, any of a data channel and a control channel. For example, a channel in an exemplary embodiment of the present disclosure may be replaced with any one of the PDSCH, the PUSCH, and the PSSCH being the data channels, or the PDCCH, the PUCCH, the PBCH, the PSCCH, and the PSBCH being the control channels.

### (Reference Signal)

In an exemplary embodiment of the present disclosure, a reference signal is a signal known to both a base station and a mobile station and may also be referred to as a reference signal (RS) or a pilot signal. The reference signal may be any of a Demodulation Reference Signal (DMRS), a Channel State Information-Reference Signal (CSI-RS), a Tracking Reference Signal (TRS), a Phase Tracking Reference Signal (PTRS), a Cell-specific Reference Signal (CRS), or a Sounding Reference Signal (SRS).

### (Time Intervals)

In an embodiment of the present disclosure, time resource units are not limited to one or a combination of slots and symbols, and may be time resource units, such as frames, superframes, subframes, slots, time slot subslots, minislots, or time resource units. such as symbols, orthogonal frequency division multiplexing (OFDM) symbols, single carrier-frequency division multiplexing access (SC-FDMA) symbols, or other time resource units. The number of symbols included in one slot is not limited to any number of symbols exemplified in the embodiments described above, and may be other numbers of symbols.

### (Frequency Band)

An exemplary embodiment of the present disclosure may be applied to either a licensed band or an unlicensed band. A channel access procedure (Listen Before Talk (LBT), carrier sense, and/or Channel Clear Assessment (CCA)) may be performed prior to transmission of each signal.

### (Communication)

An exemplary embodiment of the present disclosure may be applied to any of communication between a base station and a terminal (Uu link communication), communication between a terminal and a terminal (Sidelink communication), and communication of a Vehicle to Everything (V2X). For example, the channel in an exemplary embodiment of the present disclosure may be replaced with the PSCCH, the PSSCH, the Physical Sidelink Feedback Channel (PSFCH), the PSBCH, the PDCCH, the PUCCH, the PDSCH, the PUSCH, or the PBCH.

Further, an exemplary embodiment of the present disclosure may be applied to either terrestrial networks or a non-terrestrial network (NTN) such as communication using a satellite or a high-altitude pseudolite (High Altitude Pseudo Satellite (HAPS)). Further, an exemplary embodiment of the present disclosure may be applied to a terrestrial network having a large transmission delay compared to the symbol length or slot length, such as a network with a large cell size and/or an ultra-wideband transmission network.

### (Antenna Port)

In an exemplary embodiment of the present disclosure, the antenna port refers to a logical antenna (antenna group) configured of one or more physical antennae. For example, the antenna port does not necessarily refer to one physical antenna and may refer to an array antenna or the like configured of a plurality of antennae. In one example, the number of physical antennae configuring the antenna port need not be specified, and the antenna port may be specified as the minimum unit with which a terminal station can transmit a Reference signal. Moreover, the antenna port may be specified as the minimum unit for multiplying a weight of a Precoding vector.

### <5G NR System Architecture and Protocol Stacks>

3GPP has been working at the next release for the 5th generation cellular technology, simply called 5G, including the development of a new radio (NR) access technology operating in frequencies ranging up to 100 GHz. The first version of 5G standard was initially delivered in late 2017, which allows proceeding to trials and commercial deployments of 5G NR standard-compliant terminals, e.g., smartphones.

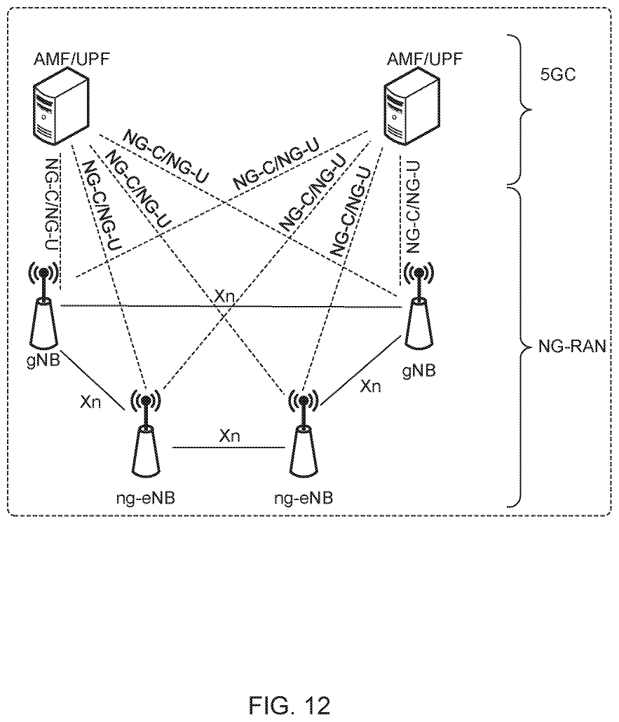

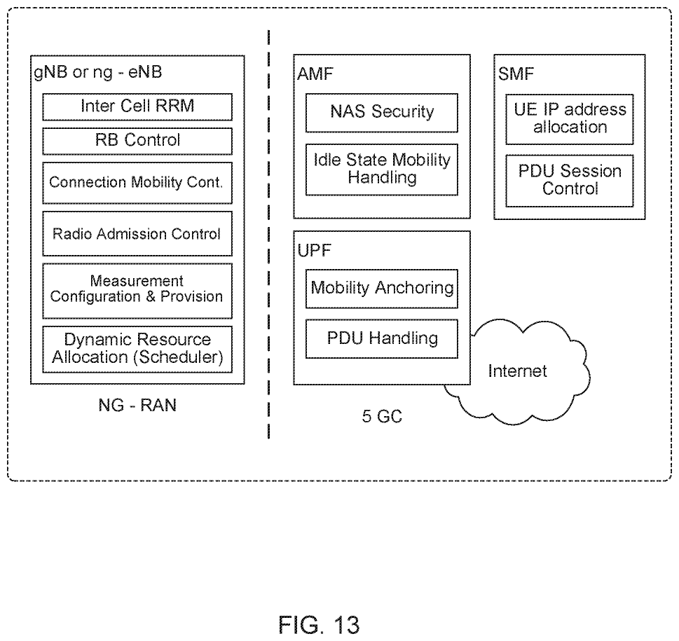

For example, the overall system architecture assumes a Next Generation-Radio Access Network (NG-RAN) that includes gNBs. The gNBs provide the NG-radio access user plane (SDAP/PDCP/RLC/MAC/PHY) and control plane (RRC) protocol terminations towards a UE. The gNBs are interconnected with each other via an Xn interface. The gNBs are also connected to the Next Generation Core (NGC) via the Next Generation (NG) interface, more specifically to the Access and Mobility Management Function (AMF; e.g. a particular core entity performing the AMF) via the NG-C interface, and to the User Plane Function (UPF; e.g., a particular core entity performing the UPF) via the NG-U interface. The NG-RAN architecture is illustrated in FIG. 12 (see, e.g., 3GPP TS 38.300 v15.6.0, section 4).

The user plane protocol stack for NR (see, e.g., 3GPP TS 38.300, section 4.4.1) includes the Packet Data Convergence Protocol (PDCP. see clause 6.4 of TS 38.300) Radio Link Control (RLC, see clause 6.3 of TS 38.300) and Medium Access Control (MAC. see clause 6.2 of TS 38.300) sublayers. which are terminated in the gNB on the network side. Additionally, a new access stratum (AS) sublayer (Service Data Adaptation Protocol: SDAP) is introduced above the PDCP (see, e.g., clause 6.5 of 3GPP TS 38.300). A control plane protocol stack is also defined for NR (see, e.g., TS 38.300, section 4.4.2). An overview of the Layer 2 functions is given in clause 6 of TS 38.300. The functions of the PDCP, RLC, and MAC sublayers are listed respectively in clauses 6.4, 6.3. and 6.2 of TS 38.300. The functions of the RRC layer are listed in clause 7 of TS 38.300.

For example, the Medium-Access-Control layer handles logical-channel multiplexing, and scheduling and scheduling-related functions, including handling of different numerologies.

The physical layer (PHY) is, for example, responsible for coding, PHY HARQ processing, modulation, multi-antenna processing. and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For example, the physical channels include a Physical Random Access Channel (PRACH), Physical Uplink Shared Channel (PUSCH), and Physical Uplink Control Channel (PUCCH) as uplink physical channels, and a Physical Downlink Shared Channel (PDSCH), Physical Downlink Control Channel (PDCCH), and Physical Broadcast Channel (PBCH) as downlink physical channels.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, the eMBB is expected to support peak data rates (20 Gbps for downlink and 10 Gbps for uplink) and user-experienced data rates in the order of three times what is offered by IMT-Advanced. Meanwhile, in a case of the URLLC, the tighter requirements are put on ultra-low latency (0.5 ms for each of UL and DL for user plane latency) and high reliability (1-10-5 within 1 ms). Finally, the mMTC may preferably require high connection density (1,000,000 devices/km² in an urban environment), large coverage in harsh environments, and extremely long-life battery for low cost devices (15 years).

Thus, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (also referred to as TTI) than an mMTC service. Furthermore, deployment scenarios with large channel delay spreads may preferably require a longer CP duration than scenarios with short delay spreads. The subcarrier spacing may be optimized accordingly to retain the similar CP overhead. NR may support more than one value of subcarrier spacing. Correspondingly, subcarrier spacing of 15 kHz, 30 KHz, 60 kHz . . . are currently considered. The symbol duration Tu and the subcarrier spacing Af are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR, for each numerology and carrier, a resource grid of subcarriers and OFDM symbols is defined for each of uplink and downlink. Each element in the resource grid is called a resource element and is identified based on the frequency index in the frequency domain and the symbol position in the time domain (see 3GPP TS 38.211 v15.6.0).

### <5G NR Functional Split Between NG-RAN and 5GC>

FIG. 13 illustrates functional split between NG-RAN and 5GC. An NG-RAN logical node is a gNB or ng-eNB. The 5GC has logical nodes AMF, UPF, and SMF.

For example, the gNB and ng-eNB host the following main functions:
Functions for radio resource management such as radio bearer control, radio admission control, connection mobility control, dynamic allocation of resources to UEs in both uplink and downlink (scheduling);
IP header compression, encryption, and integrity protection of data:
Selection of an AMF at UE attachment when no routing to an AMF can be determined from the information provided by the UE;
Routing of user plane data towards UPF(s);
Routing of control plane information towards AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling:
Transport level packet marking in the uplink;
Session management;
Support of network slicing;
QoS Flow management and mapping to data radio bearers;
Support of UEs in RRC_INACTIVE state:
Distribution function for NAS messages;
Radio access network sharing;
Dual Connectivity; and
Tight interworking between NR and E-UTRA.

The access and mobility management function (AMF) hosts the following main functions:
Non-Access Stratum (NAS) signaling termination function;
NAS signaling security;
Access Stratum (AS) security control;
Inter Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

Furthermore, the user plane function (UPF) hosts the following main functions:
Anchor point for intra-/inter-RAT mobility (when applicable);
External protocol data unit (PDU) session point of interconnect to a data network;
Packet routing and forwarding;
Packet inspection and user plane part of policy rule enforcement;
Traffic usage reporting;
Uplink classifier to support routing traffic flows to a data network;
Branching point to support multi-homed PDU session:
QoS handling for user plane (e.g. packet filtering, gating, and UL/DL rate enforcement);
Uplink traffic verification (SDF to QoS flow mapping); and
Downlink packet buffering and downlink data indication triggering.

Finally, the session management function (SMF) hosts the following main functions:
Session management;
UE IP address allocation and management;
Selection and control of UPF;
Configuration function of traffic steering at a user plane function (UPF) to route traffic to proper destination;
Control part of policy enforcement and QoS; and
Downlink data indication.

### <RRC Connection Setup and Reconfiguration Procedures>

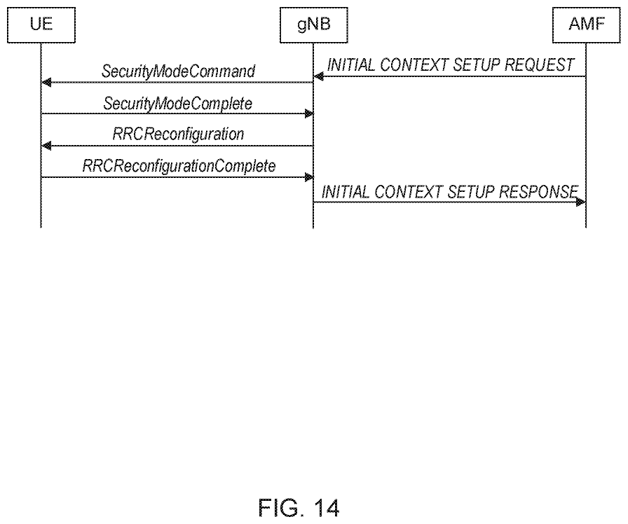

FIG. 14 illustrates some interactions between a UE, gNB, and AMF (a 5GC entity) in the context of a transition of the UE from RRC_IDLE to RRC_CONNECTED for the NAS part (see TS 38.300 v15.6.0).

RRC is a higher layer signaling (protocol) used for UE and gNB configuration. This transition involves that the AMF prepares the UE context data (including, for example, PDU session context, security key, UE radio capability, and UE security capabilities, etc.) and transmits the UE context data to the gNB with an INITIAL CONTEXT SETUP REQUEST. Then, the gNB activates the AS security with the UE, which is performed by the gNB transmitting a SecurityModeCommand message to the UE and by the UE responding to the gNB with a SecurityModeComplete message. Afterwards, the gNB performs the reconfiguration to set up the Signaling Radio Bearer 2 (SRB2) and Data Radio Bearer(s) (DRB(s)) by transmitting an RRCReconfiguration message to the UE and, in response, receiving an RRCReconfigurationComplete from the UE. For a signaling-only connection, the steps relating to the RRCReconfiguration are skipped since the SRB2 and DRBs are not setup. Finally, the gNB indicates to the AMF that the setup procedure is completed with an INITIAL CONTEXT SETUP RESPONSE.

In the present disclosure, thus, an entity (e.g., AMF, SMF, etc.) of the 5th Generation Core (5GC) is provided that includes control circuitry. which, in operation, establishes a Next Generation (NG) connection with a gNodeB. and a transmitter, which in operation, transmits an initial context setup message, via the NG connection. to the gNodeB to cause a signaling radio bearer setup between the gNodeB and user equipment (UE). In particular, the gNodeB transmits a radio resource control (RRC) signaling containing a resource allocation configuration information element (IE) to the UE via the signaling radio bearer. The UE then performs an uplink transmission or a downlink reception based on the resource allocation configuration.

### <Usage Scenarios of IMT for 2020 and Beyond>

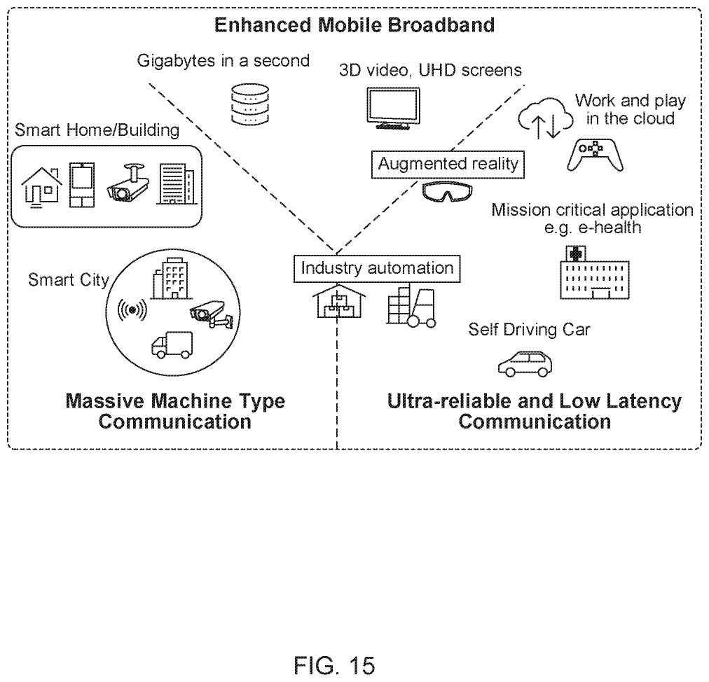

FIG. 15 illustrates some of the use cases for 5G NR. In the 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 15 illustrates some examples of envisioned usage scenarios for IMT for 2020 and beyond (see, e.g., ITU-R M. 2083 FIG. 2).

The URLLC use case has stringent requirements for capabilities such as throughput, latency, and availability. The URLLC use case has been envisioned as one of element techniques to enable future vertical applications such as wireless control of industrial manufacturing or production processes, remote medical surgery, distribution automation in a smart grid, transportation safety, etc. Ultra-reliability for the URLLC is to be supported by identifying the techniques to meet the requirements set by TR 38.913. For NR URLLC in Release 15, key requirements include a target user plane latency of 0.5 ms for uplink (UL) and 0.5 ms for downlink (DL). The general URLLC requirement for one transmission of a packet is a block error rate (BLER) of 1E−5 for a packet size of 32 bytes with a user plane latency of 1 ms.

From the physical layer perspective, reliability can be improved in a number of possible ways. The current scope for improving the reliability involves defining separate CQI tables for the URLLC, more compact DCI formats, repetition of PDCCH, etc. However, the scope may widen for achieving ultra-reliability as the NR becomes more stable and developed (for NR URLLC key requirements). Particular use cases of NR URLLC in Release 15 include augmented reality/virtual reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. The pre-emption means that a transmission for which resources have already been allocated is stopped. and the already allocated resources are used for another transmission that has been requested later but has lower latency/higher priority requirements. Accordingly, the already granted transmission is replaced with a later transmission. The pre-emption is applicable independent of the particular service type. For example, a transmission for a service-type A (URLLC) may be replaced with a transmission for a service type B (such as eMBB). Technology enhancements with respect to reliability improvement include dedicated CQI/MCS tables for the target BLER of 1E−5.

The use case of the mMTC (massive machine type communication) is characterized by a very large number of connected devices typically transmitting a relatively low volume of non-delay sensitive data. Devices are required to be low cost and to have a very long battery life. From the NR perspective, utilizing very narrow bandwidth parts is one possible solution to have power saving from the UE perspective and enable the long battery life.

As mentioned above, it is expected that the scope of reliability improvement in NR becomes wider. One key requirement to all the cases, and especially necessary for the URLLC and mMTC for example, is high reliability or ultra-reliability. Several mechanisms can be considered to improve the reliability from the radio perspective and network perspective. In general, there are a few key important areas that can help improve the reliability. These areas include compact control channel information, data/control channel repetition, and diversity with respect to the frequency, time, and/or spatial domain. These areas are applicable to reliability improvement in general, regardless of particular communication scenarios.

For NR URLLC, further use cases with tighter requirements have been considered such as factory automation, transport industry, and electrical power distribution. The tighter requirements are higher reliability (up to 10-6 level), higher availability, packet size of up to 256 bytes, time synchronization down to the order of a few us where the value can be one or a few us depending on frequency range and short latency in the order of 0.5 to 1 ms (e.g., target user plane latency of 0.5 ms) depending on the use cases.

Moreover, for NR URLLC, several technology enhancements from the physical layer perspective have been identified. These technology enhancements include Physical Downlink Control Channel (PDCCH) enhancements related to compact DCI, PDCCH repetition, and increased PDCCH monitoring. In addition, Uplink Control Information (UCI) enhancements are related to enhanced Hybrid Automatic Repeat Request (HARQ) and CSI feedback enhancements. Also, PUSCH enhancements related to mini-slot level hopping and retransmission/repetition enhancements have been identified. The term “mini-slot” refers to a transmission time interval (TTI) including a smaller number of symbols than a slot (a slot includes fourteen symbols).

### <QoS Control>

The 5G Quality of Service (QOS) model is based on QoS flows and supports both QoS flows that require guaranteed flow bit rate (GBR QoS flows) and QoS flows that do not require guaranteed flow bit rate (non-GBR QoS Flows). At the NAS level, the QoS flow is thus the finest granularity of QoS differentiation in a PDU session. A QoS flow is identified within a PDU session by a QoS flow ID (QFI) carried in an encapsulation header over the NG-U interface.

For each UE, the 5GC establishes one or more PDU sessions. For each UE, the NG-RAN establishes at least one Data Radio Bearer (DRB) together with the PDU session, for example as illustrated above with reference to FIG. 14. Additional DRB(s) for QoS flow(s) of that PDU session can be subsequently configured (it is up to NG-RAN when to do so). The NG-RAN maps packets belonging to different PDU sessions to different DRBs. NAS level packet filters in the UE and 5GC associate UL and DL packets with QoS flows, whereas AS-level mapping rules in the UE and in the NG-RAN associate UL and DL Qos flows with DRBs.

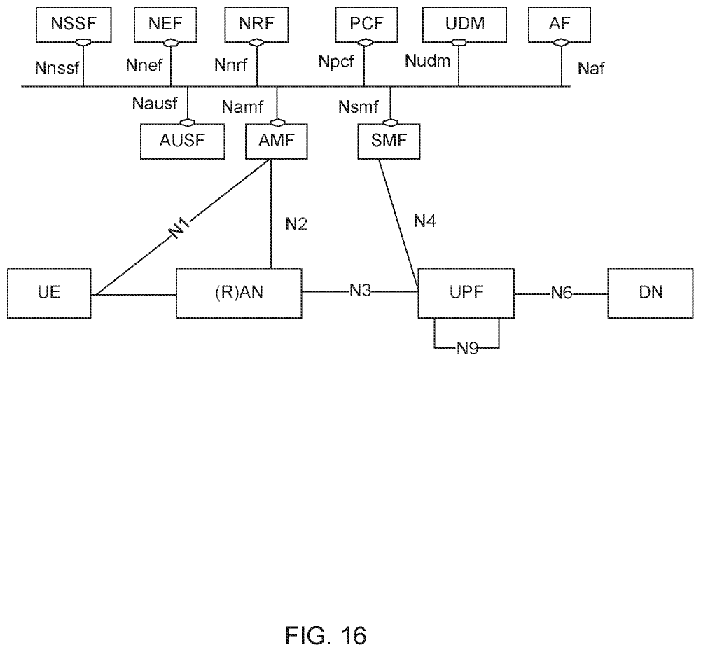

FIG. 16 illustrates a 5G NR non-roaming reference architecture (see TS 23.501 v16.1.0, section 4.23). An Application Function (AF, e.g., an external application server hosting 5G services exemplified in FIG. 15) interacts with the 3GPP core network in order to provide services, for example, to support application influence on traffic routing, accessing a Network Exposure Function (NEF) or interacting with the policy framework for policy control (see Policy Control Function, PCF), e.g., QoS control. Based on operator deployment, application functions considered to be trusted by the operator can be allowed to interact directly with relevant network functions. Application functions not allowed by the operator to access directly the network functions use the external exposure framework via the NEF to interact with relevant network functions.

FIG. 16 illustrates further functional units of the 5G architecture, namely a Network Slice Selection Function (NSSF), Network Repository Function (NRF), Unified Data Management (UDM), Authentication Server Function (AUSF), Access and Mobility Management Function (AMF). Session Management Function (SMF), and Data Network (DN, e.g., operator services, Internet access. or 3rd party services). All of or a part of the core network functions and the application services may be deployed and running on cloud computing environments.

In the present disclosure, thus, an application server (e.g., AF of the 5G architecture), is provided that includes a transmitter, which in operation, transmits a request containing a QoS requirement for at least one of the URLLC, eMMB, and mMTC services to at least one of functions (for example NEF, AMF, SMF, PCF, UPF, etc) of the 5GC to establish a PDU session including a radio bearer between a gNodeB and a UE in accordance with the QoS requirement, and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit. and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. The technique of implementing an integrated circuit is not limited to the LSI, however, and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility. such as a base station, an access point, and any other apparatus, device or system that communicates with or controls apparatuses such as those in the above non-limiting examples.

A terminal according to an embodiment of the present disclosure includes: control circuitry, which, in operation, configures a reception frequency resource for a certain control signal received after receiving a first control signal in a first frequency resource, to be a second frequency resource including a frequency resource different from the first frequency resource, the certain control signal being referred to as a second control signal; and reception circuitry, which, in operation, receives the second control signal in the second frequency resource.

In the embodiment of the present disclosure, the control circuitry configures the second frequency resource based on a third frequency resource for a data signal assigned by the first control signal.

In the embodiment of the present disclosure, the control circuitry determines a configuration of the second frequency resource based on a resource configuration associated with a bandwidth part allocated to the terminal.

In the embodiment of the present disclosure, the control circuitry determines a configuration of the second frequency resource based on a configuration of the first frequency resource.

In the embodiment of the present disclosure, the control circuitry configures the first frequency resource in at least one of a first sub-band and/or a second sub-band, and configures the second frequency resource in the first sub-band and the second sub-band.

In the embodiment of the present disclosure, the control circuitry determines to receive the second control signal in a sub-band corresponding to the first frequency resource when reception of the first control signal fails in the first sub-band and the second sub-band, and determines to receive the second control signal in a sub-band different from the sub-band corresponding to the first frequency resource when reception of the second control signal succeeds.

In the embodiment of the present disclosure, the control circuitry determines, when reception timing of a data signal assigned by the first control signal and reception timing of the second control signal are the same, to switch a reception frequency from the first frequency resource to either one of the second frequency resource and a third frequency resource to which the data signal is assigned, based on at least one of a signal type and/or a process on a signal.

A base station according to an embodiment of the present disclosure includes: control circuitry, which, in operation, configures a frequency resource for a certain control signal received by a terminal after the terminal receives a first control signal in a first frequency resource, to be a second frequency resource including a frequency resource different from the first frequency resource. the certain control signal being referred to as a second control signal; and transmission circuitry, which, in operation, transmits the second control signal in the second frequency resource.

In a communication method according to an embodiment of the present disclosure, a terminal configures a reception frequency resource for a certain control signal received after receiving a first control signal in a first frequency resource by the terminal, to be a second frequency resource including a frequency resource different from the first frequency resource, the certain control signal being referred to as a second control signal, and receives the second control signal in the second frequency resource.

In a communication method according to an embodiment of the present disclosure, a base station configures a frequency resource for a certain control signal received by a terminal after the terminal receives a first control signal in a first frequency resource, to be a second frequency resource including a frequency resource different from the first frequency resource, the certain control signal being referred to as a second control signal, and transmits the second control signal in the second frequency resource.

The disclosure of Japanese Patent Application No. 2021-053461, filed on Mar. 26, 2021, including the specification, drawings and abstract, is incorporated herein by reference in its entirety.

### INDUSTRIAL APPLICABILITY

An exemplary embodiment of the present disclosure is useful for radio communication systems.

### REFERENCE SIGNS LIST

100 Base station
101, 206 Controller
102 DCI generator
103 Higher layer signal generator
104, 207 Encoder/Modulator
105 Signal mapper
106, 208 Transmitter
107, 201 Antenna
108, 202 Receiver
109, 205 Demodulator/decoder
200 Terminal
203 Signal separator
204 DCI detector

1. A terminal, comprising:
control circuitry, which, in operation, configures a reception frequency resource for a certain control signal received after receiving a first control signal in a first frequency resource, to be a second frequency resource including a frequency resource different from the first frequency resource, the certain control signal being referred to as a second control signal; and
reception circuitry, which, in operation, receives the second control signal in the second frequency resource.

2. The terminal according to claim 1, wherein
the control circuitry configures the second frequency resource based on a third frequency resource for a data signal assigned by the first control signal.

3. The terminal according to claim 2, wherein
the control circuitry determines a configuration of the second frequency resource based on a resource configuration associated with a bandwidth part allocated to the terminal.

4. The terminal according to claim 2, wherein
the control circuitry determines a configuration of the second frequency resource based on a configuration of the first frequency resource.

5. The terminal according to claim 1, wherein
the control circuitry configures the first frequency resource in at least one of a first sub-band and/or a second sub-band, and configures the second frequency resource in the first sub-band and the second sub-band.

6. The terminal according to claim 5, wherein
the control circuitry determines to receive the second control signal in a sub-band corresponding to the first frequency resource when reception of the first control signal fails in the first sub-band and the second sub-band, and determines to receive the second control signal in a sub-band different from the sub-band corresponding to the first frequency resource when reception of the second control signal succeeds.

7. The terminal according to claim 1, wherein
the control circuitry determines, when reception timing of a data signal assigned by the first control signal and reception timing of the second control signal are the same, to switch a reception frequency from the first frequency resource to either one of the second frequency resource and a third frequency resource to which the data signal is assigned, based on at least one of a signal type and/or a process on a signal.

8. A base station, comprising:
control circuitry, which, in operation, configures a frequency resource for a certain control signal received by a terminal after the terminal receives a first control signal in a first frequency resource, to be a second frequency resource including a frequency resource different from the first frequency resource, the certain control signal being referred to as a second control signal; and
transmission circuitry, which, in operation, transmits the second control signal in the second frequency resource.

9. A communication method, comprising:
configuring, by a terminal, a reception frequency resource for a certain control signal received after receiving a first control signal in a first frequency resource by the terminal, to be a second frequency resource including a frequency resource different from the first frequency resource, the certain control signal being referred to as a second control signal; and
receiving, by the terminal, the second control signal in the second frequency resource.

10. A communication method, comprising:
configuring, by a base station, a frequency resource for a certain control signal received by a terminal after the terminal receives a first control signal in a first frequency resource, to be a second frequency resource including a frequency resource different from the first frequency resource, the certain control signal being referred to as a second control signal; and
transmitting, by the base station, the second control signal in the second frequency resource.
